(19) United States
(12) Patent Application Publication
(10) Pub. No.: US 2017/0326690 A1
(43) Pub. Date: Nov. 16, 2017

(54) MULTI-COMPONENT ALLOY PRODUCTS, AND METHODS OF MAKING AND USING THE SAME

(71) Applicant: ARCONIC INC., Pittsburgh, PA (US)

(72) Inventors: David W. Heard, Pittsburgh, PA (US); Gen Satoh, Murrysville, PA (US); Cagatay Yanar, Pittsburgh, PA (US); Vivek M. Sample, Murrysville, PA (US); Jen C. Lin, Export, PA (US); Andreas Kulovits, Pittsburgh, PA (US); Raymond J. Kilmer, Pittsburgh, PA (US); Sherri McCleary, Apollo, PA (US); Donald J. Spinella, Greensburg, PA (US); Kyle L. Williams, Shelocta, PA (US)

(21) Appl. No.: 15/596,325

(22) Filed: May 16, 2017

Related U.S. Application Data
(60) Provisional application No. 62/336,920, filed on May 16, 2016.
(60) Provisional application No. 62/385,887, filed on Sep. 9, 2016.
(60) Provisional application No. 62/456,578, filed on Feb. 8, 2017.

(51) Int. Cl. B23K 35/22; B33Y 10/00; B33Y 30/00; B33Y 40/00

(52) U.S. Cl. CPC B23K 35/22; B33Y 40/00; B33Y 10/00; B33Y 30/00

(57) ABSTRACT

The present disclosure relates to new metal powders, wires and other physical forms for use in additive manufacturing, welding and cladding, and multi-component alloy products made from such metal powders, wires and forms via additive manufacturing, welding and cladding. The composition(s) and/or physical properties of the metal powders, wires or forms may be tailored. In turn, additive manufacturing, welding and cladding may be used to produce a tailored multi-component alloy product.

### CROSS-REFERENCE TO RELATED APPLICATION

This patent application claims benefit of priority of U.S. Provisional Patent Application No. 62/336,920, filed May 16, 2016, and claims benefit of priority of U.S. Provisional Patent Application No. 62/385,887, filed Sep. 9, 2016, and claims benefit of priority of U.S. Provisional Patent Application No. 62/456,578, filed Feb. 8, 2017, each of which is incorporated herein by reference in its entirety.

### BACKGROUND

Alloy systems are generally categorized by the major element, i.e., the host element, such as iron, aluminum, nickel, and titanium, for instance, where one element is the major element, and the others are minor elements. For example, steels are mainly made of iron and aluminum alloys are mainly made of aluminum. Bronze consists primarily of copper and about 12% tin. Brass is a copper-based alloy having zinc.

### SUMMARY OF THE INVENTION

Broadly, the present disclosure relates to metal powders, wires and other forms (e.g., elongated forms) having a variety of cross-sectional shapes, such as extruded tubes and bars, for use in additive manufacturing, welding, cladding and other metal deposition techniques, and multi-component alloy products made from such materials (e.g., by via additive manufacturing and/or welding). The composition(s) and/or physical properties of the metal powders or wires may be tailored. In turn, additive manufacturing may be used to produce tailored multi-alloy product materials.

As used herein, “multi-component alloy product” and the like means a product with a metal matrix, where at least four different elements make up the matrix, and where the multi-component product comprises 5-35 at. % of the at least four elements. In one embodiment, at least five different elements make up the matrix, and the multi-component product comprises 5-35 at. % of the at least five elements. In one embodiment, at least six different elements make up the matrix, and the multi-component product comprises 5-35 at. % of the at least six elements. In one embodiment, at least seven different elements make up the matrix, and the multi-component product comprises 5-35 at. % of the at least seven elements. In one embodiment, at least eight different elements make up the matrix, and the multi-component product comprises 5-35 at. % of the at least eight elements. As described below, additives may also be used relative to the matrix of the multi-component alloy product.

### BRIEF DESCRIPTION OF THE DRAWINGS

FIG. 1 is a schematic, cross-sectional view of an additively manufactured product (100) having a generally homogenous microstructure.

FIGS. 2a-2d are schematic, cross-sectional views of an additively manufactured product produced from a single metal powder and having a first matrix region (200) and a second region (300) of a multiple metal phase, with FIGS. 2b-2d being deformed relative to the original additively manufactured product illustrated in FIG. 2a.

FIGS. 3a-3f are schematic, cross-sectional views of additively manufactured products having a first region (400) and a second region (500) different than the first region, where the first region is produced via a first metal powder and the second region is produced via a second metal powder, different than the first metal powder.

FIG. 4 is a flow chart illustrating some potential processing operations that may be completed relative to an additively manufactured multi-component alloy product. Although the dissolving (20), working (30), and precipitating (40) steps are illustrated as being in series, the steps may be completed in any applicable order.

FIG. 5a is a schematic view of one embodiment of using electron beam additive manufacturing to produce a multi-component alloy body.

FIG. 5b illustrates one embodiment of a wire useful with the electron beam embodiment of FIG. 5a, the wire having an outer tube portion and a volume of particles contained within the outer tube portion.

FIGS. 5c-5f illustrates embodiments of wires useful with the electron beam embodiment of FIG. 5a and/or other welding apparatus, the wires having an elongate outer tube portion and at least one second elongate inner tube portion. FIGS. 5c and 5e are schematic side views of the wires, and FIGS. 5d and 5f are top-down schematic views of the wires of FIGS. 5c and 5e, respectively.

FIG. 5g illustrates one embodiment of a wire useful with the electron beam embodiment of FIG. 5a, the wire having at least first and second fibers, wherein the first and second fibers are of different compositions.

FIGS. 5h-5m illustrates embodiments of wires useful with producing multi-component alloy products via the electron beam embodiment of FIG. 5a and/or other welding apparatus.

FIG. 6a is a schematic view of one embodiment of a powder bed additive manufacturing system using an adhesive head.

FIG. 6b is a schematic view of another embodiment of a powder bed additive manufacturing system using a laser.

FIG. 6c is a schematic view of another embodiment of a powder bed additive manufacturing system using multiple powder feed supplies and a laser.

FIG. 7 is a schematic view of another embodiment of a powder bed additive manufacturing system using multiple powder feed supplies to produce a tailored metal powder blend.

### DETAILED DESCRIPTION

As noted above, the present disclosure relates to metal powders, wires and other forms (e.g., elongated forms) having a variety of cross-sectional shapes, such as extruded tubes and bars, for use in additive manufacturing, welding, cladding and other metal deposition techniques, and multi-component alloy products made from such materials (e.g., by via additive manufacturing and/or welding). The composition(s) and/or physical properties of the metal powders or wires may be tailored. In turn, additive manufacturing may be used to produce tailored multi-alloy product materials.

The new multi-component alloy (“MCA”) products are generally produced via a method that facilitates selective heating of powders or wires to temperatures above the liquidus temperature of the particular multi-component alloy product to be formed, thereby forming a molten pool followed by rapid solidification of the molten pool. The rapid solidification facilitates maintaining various alloying elements in solid solution. In one embodiment, the new multi-component alloy products are produced via additive manufacturing techniques. Additive manufacturing techniques facilitate the selective heating of powders or wires above the liquidus temperature of the particular multi-component alloy, thereby forming a molten pool followed by rapid solidification of the molten pool

As used herein, “additive manufacturing” means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. The multi-component alloy products described herein may be manufactured via any appropriate additive manufacturing technique described in this ASTM standard, such as binder jetting, directed energy deposition, material extrusion, material jetting, powder bed fusion, or sheet lamination, among others. In one embodiment, an additive manufacturing process includes depositing successive layers of one or more powders and then selectively melting and/or sintering the powders to create, layer-by-layer, a multi-component alloy product. In one embodiment, an additive manufacturing processes uses one or more of Selective Laser Sintering (SLS), Selective Laser Melting (SLM), and Electron Beam Melting (EBM), among others. In one embodiment, an additive manufacturing process uses an EOSINT M 280 Direct Metal Laser Sintering (DMLS) additive manufacturing system, or comparable system, available from EOS GmbH (Robert-Stirling-Ring 1, 82152 Krailling/Munich, Germany).

In one embodiment, a method comprises (a) dispersing a powder in a bed, (b) selectively heating a portion of the powder (e.g., via a laser) to a temperature above the liquidus temperature of the particular multi-component alloy product to be formed, (c) forming a molten pool and (d) cooling the molten pool at a cooling rate of at least 1000° C. per second. In one embodiment, the cooling rate is at least 10,000° C. per second. In another embodiment, the cooling rate is at least 100,000° C. per second. In another embodiment, the cooling rate is at least 1,000,000° C. per second. Steps (a)-(d) may be repeated as necessary until the multi-component alloy product is completed.

As used herein, “metal powder” means a material comprising a plurality of metal particles, optionally with some non-metal particles. The metal particles of the metal powder may be all the same type of metal particles, or may be a blend of metal particles, optionally with non-metal particles, as described below. The metal particles of the metal powder may have pre-selected physical properties and/or pre-selected composition(s), thereby facilitating production of tailored multi-component alloy products. The metal powders may be used in a metal powder bed to produce a tailored multi-component alloy product via additive manufacturing. Similarly, any non-metal particles of the metal powder may have pre-selected physical properties and/or pre-selected composition(s), thereby facilitating production of tailored multi-component alloy products. The non-metal powders may be used in a metal powder bed to produce a tailored multi-component alloy product via additive manufacturing

As used herein, “metal particle” means a particle comprising at least one metal. The metal particles may be one-metal particles, multiple metal particles, and metal-non-metal (M-NM) particles, as described below. The metal particles may be produced, for example, via gas atomization.

As used herein, a “particle” means a minute fragment of matter having a size suitable for use in the powder of the powder bed (e.g., a size of from 5 microns to 100 microns). Particles may be produced, for example, via gas atomization.

For purposes of the present patent application, a “metal” is one of the following elements: aluminum (Al), silicon (Si), lithium (Li), any useful element of the alkaline earth metals, any useful element of the transition metals, any useful element of the post-transition metals, and any useful element of the rare earth elements.

As used herein, useful elements of the alkaline earth metals are beryllium (Be), magnesium (Mg), calcium (Ca), and strontium (Sr).

As used herein, useful elements of the transition metals are any of the metals shown in Table 1, below.

TABLE 1
Transition Metals

| Group | 4 | 5 | 6 | 7 | 8 | 9 | 10 | 11 | 12 |
|---|---|---|---|---|---|---|---|---|---|
| Period 4 | Ti | V | Cr | Mn | Fe | Co | Ni | Cu | Zn |
| Period 5 | Zr | Nb | Mo | | Ru | Rh | Pd | Ag | |
| Period 6 | Hf | Ta | W | Re | | | Pt | Au | |

As used herein, useful elements of the post-transition metals are any of the metals shown in Table 2, below.

TABLE 2
Post-Transition Metals

| Group | 13 | 14 | 15 |
|---|---|---|---|
| Period 4 | Ga | Ge | |
| Period 5 | In | Sn | |
| Period 6 | | Pb | Bi |

As used herein, useful elements of the rare earth elements are scandium, yttrium and any of the fifteen lanthanides elements. The lanthanides are the fifteen metallic chemical elements with atomic numbers 57 through 71, from lanthanum through lutetium.

As used herein non-metal particles are particles essentially free of metals. As used herein “essentially free of metals” means that the particles do not include any metals, except as an impurity. Non-metal particles include, for example, boron nitride (BN) and boron carbine (BC) particles, carbon-based polymer particles (e.g., short or long chained hydrocarbons (branched or unbranched)), carbon nanotube particles, and graphene particles, among others. The non-metal materials may also be in non-particulate form to assist in production or finalization of the multi-component alloy product.

In one embodiment, at least some of the metal particles of the metal powder consists essentially of a single metal (“one-metal particles”). The one-metal particles may consist essentially of any one metal useful in producing a multi-component alloy, such as any of the metals defined above.

In another embodiment, at least some of the metal particles of the metal powder include multiple metals (“multiple-metal particles”). For instance, a multiple-metal particle may comprise two or more of any of the metals listed in the definition of metals, above.

In one embodiment, at least some of the metal particles of the metal powder are metal-nonmetal (M-NM) particles. Metal-nonmetal (M-NM) particles include at least one metal with at least one non-metal. Examples of non-metal elements include oxygen, carbon, nitrogen and boron. Examples of M-NM particles include metal oxide particles (e.g., Al₂O₃), metal carbide particles (e.g., TiC, SiC), metal nitride particles (e.g., Si₃N₄), metal borides (e.g., TiB₂), and combinations thereof

The metal particles and/or the non-metal particles of the metal powder may have tailored physical properties. For example, the particle size, the particle size distribution of the powder, and/or the shape of the particles may be pre-selected. In one embodiment, one or more physical properties of at least some of the particles are tailored in order to control at least one of the density (e.g., bulk density and/or tap density), the flowability of the metal powder, and/or the percent void volume of the metal powder bed (e.g., the percent porosity of the metal powder bed). For example, by adjusting the particle size distribution of the particles, voids in the powder bed may be restricted, thereby decreasing the percent void volume of the powder bed. In turn, multi-component alloy products having an actual density close to the theoretical density may be produced. In this regard, the metal powder may comprise a blend of powders having different size distributions. For example, the metal powder may comprise a blend of a first metal powder having a first particle size distribution and a second metal powder having a second particle size distribution, wherein the first and second particle size distributions are different. The metal powder may further comprise a third metal powder having a third particle size distribution, a fourth metal powder having a fourth particle size distribution, and so on. Thus, size distribution characteristics such as median particle size, average particle size, and standard deviation of particle size, among others, may be tailored via the blending of different metal powders having different particle size distributions. In one embodiment, a final multi-component alloy product realizes a density within 98% of the product's theoretical density. In another embodiment, a final multi-component alloy product realizes a density within 98.5% of the product's theoretical density. In yet another embodiment, a final multi-component alloy product realizes a density within 99.0% of the product's theoretical density. In another embodiment, a final multi-component alloy product realizes a density within 99.5% of the product's theoretical density. In yet another embodiment, a final multi-component alloy product realizes a density within 99.7%, or higher, of the product's theoretical density.

The metal powder may comprise any combination of one-metal particles, multiple-metal particles, M-NM particles and/or non-metal particles to produce the tailored multi-component alloy product, and, optionally, with any pre-selected physical property. For example, the metal powder may comprise a blend of a first type of metal particle with a second type of particle (metal or non-metal), wherein the first type of metal particle is a different type than the second type (compositionally different, physically different or both). The metal powder may further comprise a third type of particle (metal or non-metal), a fourth type of particle (metal or non-metal), and so on. As described in further detail below, the metal powder may be the same metal powder throughout the additive manufacturing of the multi-component alloy product, or the metal powder may be varied during the additive manufacturing process.

As noted above, additive manufacturing may be used to create, layer-by-layer, a multi-component alloy product. In one embodiment, a metal powder bed is used to create a multi-component alloy product (e.g., a tailored multi-component alloy product). As used herein a “metal powder bed” means a bed comprising a metal powder. During additive manufacturing, particles of different compositions may melt (e.g., rapidly melt) and then solidify (e.g., in the absence of homogenous mixing). Thus, multi-component alloy products having a homogenous or non-homogeneous microstructure may be produced.

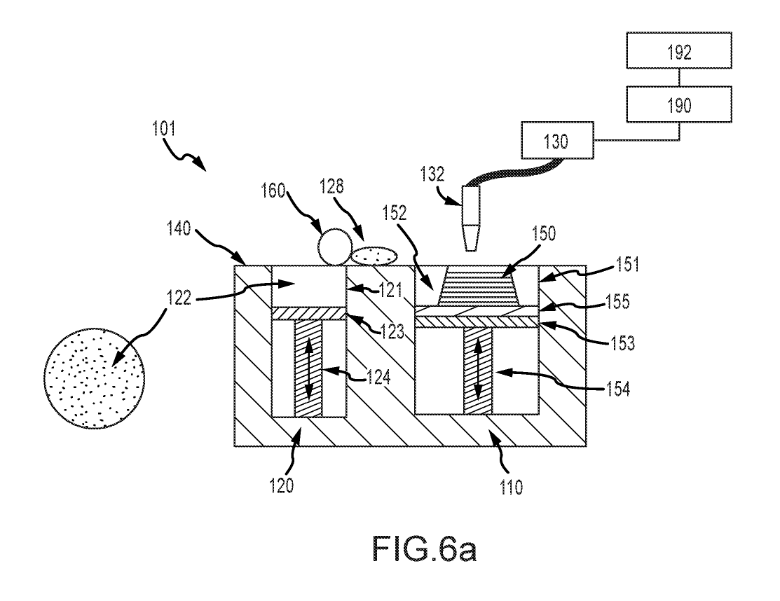

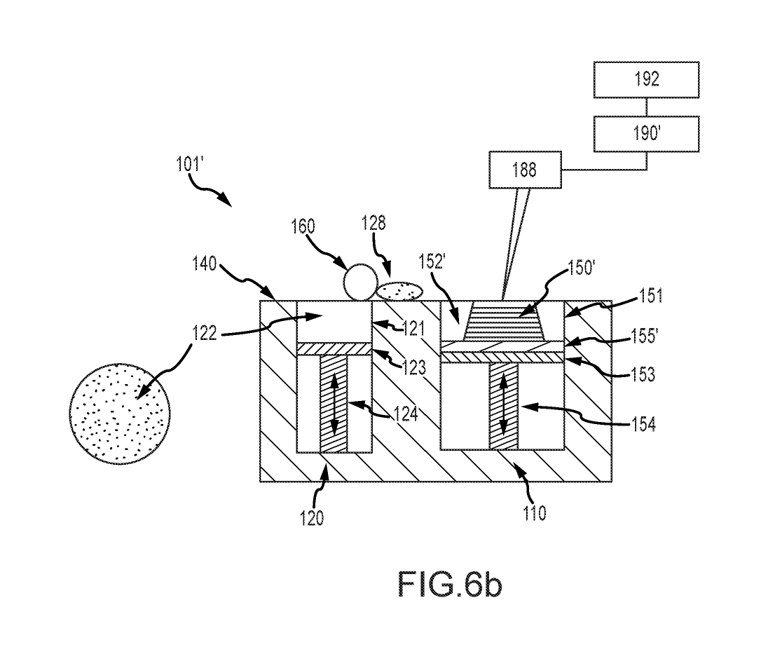

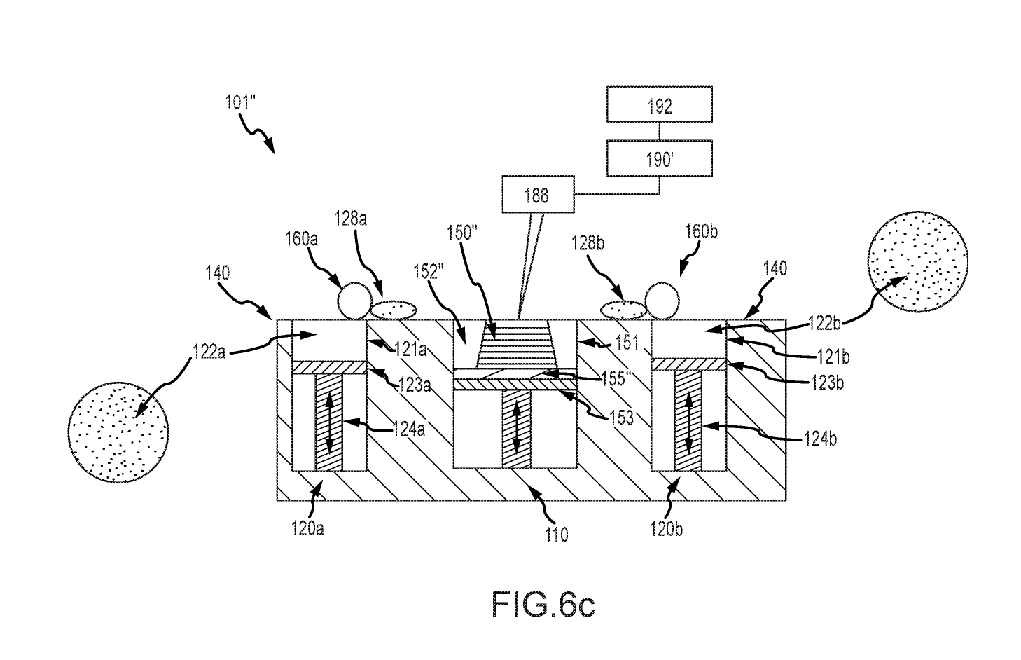

One approach for producing a tailored additively manufactured product using a metal powder bed arrangement is illustrated in FIG. 6a. In the illustrated approach, the system (101) includes a powder bed build space (110), a powder supply (120), and a powder spreader (160). The powder supply (120) includes a powder reservoir (121), a platform (123), and an adjustable device (124) coupled to the platform (123). The adjusting device (124) is adjustable (via a control system, not shown) to move the platform (123) up and down within the powder reservoir (121). The build space (110) includes a build reservoir (151), a build platform (153), and an adjustable device (154) coupled to the build platform (153). The adjustable device (154) is adjustable (via a control system, not shown) to move the build platform (153) up and down within the build reservoir (151), as appropriate, to facilitate receipt of metal powder feedstock (122) from the powder supply (120) and/or production of a tailored 3-D multi-component alloy part (150).

Powder spreader (160) is connected to a control system (not shown) and is operable to move from the powder reservoir (121) to the build reservoir (151), thereby supplying preselected amount(s) of powder feedstock (122) to the build reservoir (151). The powder feedstock (122) may be a multi-component alloy feedstock, and may include at least four different elements (e.g., metals), where each of the at least four different elements make-up 5-35 at. % of the powder feedstock. In the illustrated embodiment, the powder spreader (160) is a roller and is configured to roll along a distribution surface (140) of the system to gather a preselected volume (128) of powder feedstock (122) and move this preselected volume (128) of powder feedstock (122) to the build reservoir (151) (e.g., by pushing/rolling the powder feedstock). For instance, platform (123) may be moved to the appropriate vertical position, wherein a preselected volume (128) of the powder feedstock (122) lies above the distribution surface (140). Correspondingly, the build platform (153) of the build space (110) may be lowered to accommodate the a preselected volume (128) of the powder feedstock (122). As powder spreader (160) moves from an entrance side (the left-hand side in FIG. 6a) to an exit side (the right-hand side of FIG. 6a) of the powder reservoir (121), the powder spreader (160) will gather most or all of the preselected volume (128) of the powder feedstock (122). As powder spreader (160) continues along the distribution surface (140), the gathered volume of powder (128) will be moved to the build reservoir (151) and distributed therein, such as in the form of a layer of metal powder. The powder spreader (160) may move the gathered volume (128) of the metal powder feedstock (122) into the build reservoir (151), or may move the gathered volume (128) onto a surface co-planar with the distribution surface (140), to produce a layer of metal powder feedstock. In some embodiments, the powder spreader (160) may pack/densify the gathered powder (128) within the build reservoir (151). While the powder spreader (160) is shown as being a cylindrical roller, the spreader may be of any appropriate shape, such as rectangular (e.g., when a squeegee is used), or otherwise. In this regard, the powder spreader (160) may roll, push, scrape, or otherwise move the appropriate gathered volume (128) of the metal powder feedstock (122) to the build reservoir (151), depending on its configuration. Further, in other embodiments (not illustrated) a hopper or similar device may be used to provide a powder feedstock to the distribution surface (140) and/or directly to the build reservoir (151).

After the powder spreader (160) has distributed the gathered volume of powder (128) to the build reservoir (151), the powder spreader (160) may then be moved away from the build reservoir (151), such as to a neutral position, or a position upstream (to the left of in FIG. 6a) of the entrance side of the powder reservoir (121). Next, the system (101) uses an adhesive supply (130) and its corresponding adhesive head (132) to selectively provide (e.g., spray) adhesive to the gathered volume of powder (128) contained in the build reservoir (151). Specifically, the adhesive supply (130) is electrically connected to a computer system (192) having a 3-D computer model of a 3-D multi-component alloy part, and a controller (190). After the gathered volume (128) of the powder has been provided to the build reservoir (151), the controller (190) of the adhesive supply (130) moves the adhesive head (132) in the appropriate X-Y directions, spraying adhesive onto the powder volume in accordance with the 3-D computer model of the computer (192).

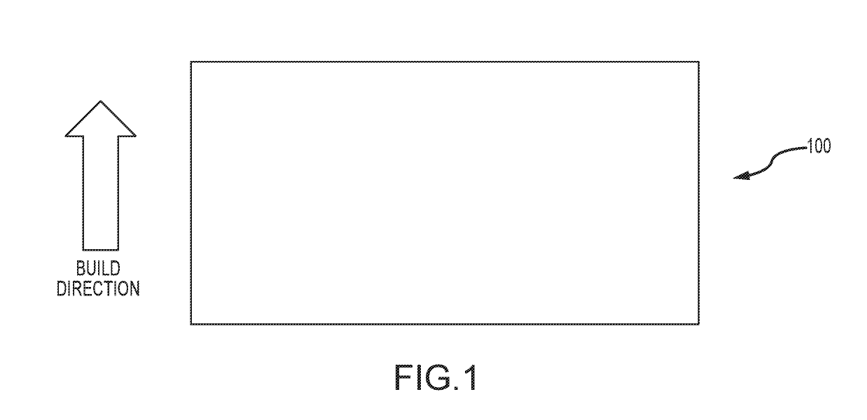

Upon conclusion of the adhesive spraying step, the build platform (153) may be lowered, the powder supply platform (123) may be raised, and the process repeated, with multiple gathered volumes (128) being serially provided to the build reservoir (151) via powder spreader (160), until a multi-layer, tailored 3-D multi-component alloy part (150) is completed. As needed, a heater (not illustrated) may be used between one or more spray operations to cure (e.g., partially cure) any powder sprayed with adhesive. The final tailored 3-D multi-component alloy part may then be removed from the build space (110), wherein excess powder (152) (not having being substantively sprayed by the adhesive) is removed, leaving only the final “green” tailored 3-D multi-component alloy part (150). The final green tailored 3-D multi-component alloy part (150) may then be heated in a furnace or other suitable heating apparatus, thereby sintering the part and/or removing volatile component(s) (e.g., from the adhesive supply) from the part. In one embodiment, the final tailored 3-D multi-component alloy part (150) comprises a homogenous or near homogenous distribution of the metal powder feedstock (e.g., as shown in FIG. 1). Optionally, a build substrate (155) may be used to build the final tailored 3-D multi-component alloy part (150), and this build substrate (155) may be incorporated into the final tailored 3-D multi-component alloy part (150), or the build substrate may be excluded from the final tailored 3-D multi-component alloy part (150). The build substrate (155) itself may be a metal or metallic product (different or the same as the 3-D multi-component alloy part), or may be another material (e.g., a plastic or a ceramic).

As described above, the powder spreader (160) may move the gathered volume (128) of metal powder feedstock (122) to the build reservoir (151) via distribution surface (140). In another embodiment, at least one of the build space (110) and the powder supply (120) are operable to move in the lateral direction (e.g., in the X-direction) such that one or more outer surfaces of the build space (110) and powder supply (120) are in contact. In turn, powder spreader (160) may move the preselected volume (128) of the metal powder feedstock (122) to the build reservoir (151) directly and in the absence of any intervening surfaces between the build reservoir (151) and the powder reservoir (121).

As noted, the powder supply (120) includes an adjustable device (124) which is adjustable (via a control system, not shown) to move the platform (123) up and down within the powder reservoir (151). In one embodiment, the adjustable device (124) is in the form of a screw or other suitable mechanical apparatus. In another embodiment, the adjustable device (124) is a hydraulic device. Likewise, the adjustable device (154) of the build space may be a mechanical apparatus (e.g., a screw) or a hydraulic device.

As noted above, the powder reservoir (121) includes a metal powder feedstock (122), wherein at least some metal is present. This powder feedstock (122) may include one-metal particles, multiple-metal particles, M-NM particles, non-metal particles, and combinations thereof, wherein at least one of the one-metal particles, multiple-metal particles, and/or M-NM particles is present. Thus, tailored 3-D multi-component alloy products may be produced. In one approach, the powder feedstock (122) includes a sufficient amount of the one-metal particles, multiple-metal particles, M-NM particles, non-metal particles, and combinations thereof to make a dispersion-strengthened multi-component alloy. In one embodiment, the dispersion-strengthened multi-component alloy is an oxide dispersion strengthened multi-component alloy (e.g., containing a sufficient amount of oxides to dispersion strengthen the multi-component alloy product, but generally not greater than 10 wt. % oxides). In this regard, the metal powder feedstock (122) may include M-O particles, where M is a metal and O is oxygen. Suitable M-O particles include Y₂O₃, Al₂O₃, TiO₂, and La₂O₃, among others.

FIG. 6b utilizes generally the same configuration as FIG. 6a, but uses a laser system (188) (or an electron beam) in lieu of an adhesive system to produce a 3-D multi-component alloy product (150′). All the embodiments and descriptions of FIG. 6a, therefore, apply to the embodiment of FIG. 6b, with the exception of the adhesive system (130). Instead, a laser (188) is electrically connected to the computer system (192) having a 3-D computer model of a 3-D multi-component alloy part, and a suitable controller (190′). After a gathered volume (128) of the powder has been provided to the build reservoir (151), the controller (190′) of the laser (188) moves the laser (188) in the appropriate X-Y directions, heating selective portions of the powder volume in accordance with the 3-D computer model of the computer (192). In doing so, the laser (188) may heat a portion of the powder to a temperature above the liquidus temperature of the product to be formed, thereby forming a molten pool. The laser may be subsequently moved and/or powered off (e.g., via controller 190′), thereby cooling the molten pool at a cooling rate of at least 1,000° C. per second, thereby forming a portion of the final tailored 3-D multi-component alloy part (150′). In one embodiment, the cooling rate is at least 10,000° C. per second. In another embodiment, the cooling rate is at least 100,000° C. per second. In another embodiment, the cooling rate is at least 1,000,000° C. per second. Upon conclusion of the lasing process, the build platform (153) may be lowered, and the process repeated until the multi-layer, tailored 3-D multi-component alloy part (150′) is completed. As described above, the final tailored 3-D multi-component alloy part may then be removed from the build space (110), wherein excess powder (152′) (not having being substantively lased) is removed. When an electron beam is used as the laser (188), the cooling rates may be at least 10° C. per second (inherently or via controlled cooling), or at least 100° C. per second, or higher, thereby forming a portion of the final tailored 3-D multi-component alloy part (150′).

In one embodiment, the build space (110), includes a heating apparatus (not shown), which may intentionally heat one or more portions of the build reservoir (151) of the build space (110), or powders or lased objects contained therein. In one embodiment, the heating apparatus heats a bottom portion of the build reservoir (151). In another embodiment, the heating apparatus heats one or more side portions of the build reservoir (151). In another embodiment, the heating apparatus heats at least portions of the bottom and sides of the build reservoir (151). The heating apparatus may be useful, for instance, to control the cooling rate and/or relax residual stress(es) during cooling of the lased 3-D multi-component alloy part (150′). Thus, higher yields may be realized for some multi-component alloy products. In one embodiment, controlled heating and/or cooling are used to produce controlled local thermal gradients within one or more portions of the lased 3-D multi-component alloy part (150′). The controlled local thermal gradients may facilitate, for instance, tailored textures or tailored microstructures within the final lased 3-D multi-component alloy part (150′). The system of FIG. 6b can use any of the metal powder feedstocks described herein. Further, a build substrate (155′) may be used to build the final tailored 3-D multi-component alloy part (150′), and this build substrate (155′) may be incorporated into the final tailored 3-D multi-component alloy part (150′), or the build substrate may be excluded from the final tailored 3-D multi-component alloy part (150′). The build substrate (155′) itself may be a metal or metallic product (different or the same as the 3-D multi-component alloy part), or may be another material (e.g., a plastic or a ceramic).

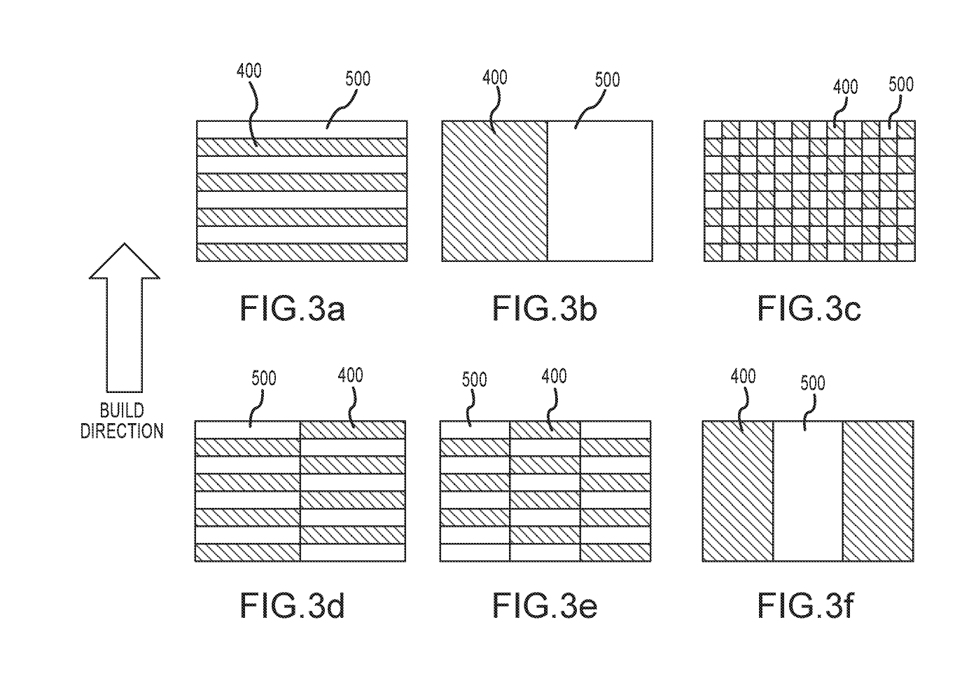

In another approach, and referring now to FIG. 6c, multiple powder supplies (120a, 120b) may be used to feed multiple powder feedstocks (122a, 122b) to the build reservoir (151) to facilitate production of tailored 3-D multi-component alloy products. In the embodiment of FIG. 6c, a first powder spreader (160a) may feed a first powder feedstock (122a) of the first powder supply (120a) to the build reservoir (151), and second powder spreader (160b) may feed a second powder feedstock (122b) of the second powder supply (120b) to the build reservoir (151). The first and second powder feedstocks (122a, 122b) may be provided in any suitable amount and in any suitable order to facilitate production of tailored 3-D multi-component alloy products. As one specific example, a first layer of a 3-D multi-component alloy product may be produced using the first powder feedstock (122a), and as described above relative to FIGS. 6a-6b. A second layer of the 3-D multi-component alloy product may be subsequently produced using the second powder feedstock (122b), and as described above relative to FIGS. 6a-6b. Thus, tailored 3-D multi-component alloy products may be produced. In one embodiment, the second layer overlies the first layer (e.g., as shown in FIG. 3a, showing second portions (500) overlaying first portion (400)). In another embodiment, the first and second layers are separated by other materials (e.g., a third layer of a third material).

As another example, the first powder spreader (160a) may only partially provide the first feedstock (122a) to the build reservoir (151) specifically and intentionally leaving a gap. Subsequently, the second powder spreader (160b) may provide the second feedstock (122b) to the build reservoir (151), at least partially filling the gap. The laser (188) may be utilized at any suitable time(s) relative to these first and second rolling operations. In turn, multi-region 3-D multi-component alloy products may be produced with a first portion (400) being laterally adjacent to the second portion (500) (e.g., as shown in FIG. 3b). Indeed, the system 101″ may operate the build space (110), the powder supplies (120a, 120b) and the powder spreader (160a, 160b), as appropriate, to produce any of the embodiments illustrated in FIGS. 3a-3f

The first and second powder feedstocks (122a, 122b) may have the same compositions (e.g., for speed/efficiency purposes), but generally have different compositions. In one approach, the first feedstock (122a) comprises a first composition blend and the second feedstock (122b) comprises a second composition blend, different than the first composition. At least one of the first and second powder feedstocks (122a, 122b) include a sufficient amount of metal to make a multi-powder blend, the multi-powder blend having at least four different elements, each of the at least four different elements making up 5-35 at. % of the MCA powder blend. Thus, tailored 3-D multi-component alloy products may be produced. Any combinations of first and second feedstocks (122a, 122b) can be used to produce tailored 3-D multi-component alloy products, such as any of the multi-component alloy products illustrated in FIGS. 1, 2a-2d, and 3a-3f. In one approach, each of the first and second powder feedstock (122a, 122b) is a multi-component alloy feedstock, where at least four different elements make up 5-35 at. % of the first powder feedstock (122a), and where at least four different elements make up 5-35 at. % of the second powder feedstock (122b), where the second feedstock (122b) includes at least one component different than the first feedstock (122a). In one embodiment, the second feedstock (122b) includes at least two components different than the first feedstock (122a). In another embodiment, the second feedstock (122b) includes at least three components different than the first feedstock (122a). In another embodiment, the first and second feedstocks (122a, 122b) are non-overlapping, wherein the second feedstock (122b) is absent of any of the components making-up the first feedstock (122a). In yet another embodiment, the first and second feedstocks (122a, 122b) are partially overlapping, wherein the second feedstock (122b) includes at least one component of the first feedstock (122a). In one embodiment, the second feedstock (122b) includes at least two components of the first feedstock (122a). In one embodiment, the second feedstock (122b) includes at least three components of the first feedstock (122a). Any combinations of first and second feedstocks (122a, 122b) can be used to produce multi-region MCA products.

As with the approaches of FIGS. 6a-6b, above, while the powder spreaders (160a, 160b) are shown as being cylindrical, the powder spreaders (160a, 160b) may be of any appropriate shape, such as rectangular or otherwise. In this regard, the powder spreaders (160a, 160b) may roll, push, scrape, or otherwise move the feedstocks (122a, 122b) to the build reservoir (151), depending on their configurations. Also, optionally, a build substrate (155″) may be used to build the final tailored 3-D multi-component alloy part (150″), and this build substrate (155″) may be incorporated into the final tailored 3-D multi-component alloy part (150″), or the build substrate may be excluded from the final tailored 3-D multi-component alloy part (150″). The build substrate (155″) itself may be a metal or metallic product (different or the same as the 3-D multi-component alloy part), or may be another material (e.g., a plastic or a ceramic). Although FIG. 6c is illustrated as using a laser (188), the system of FIG. 6c could alternatively use an adhesive system as described above relative to FIG. 6a.

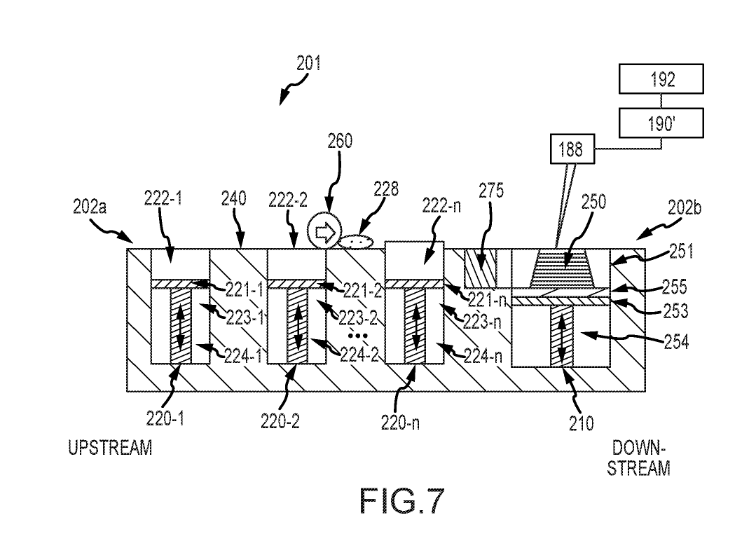

FIG. 7 is a schematic view of a system (201) for making a multi-powder feedstock. In the illustrated embodiment, the system (201) is shown as providing a multi-powder feedstock to a powder bed build space, such as those described above relative to FIGS. 6a-6c, however, the system (201) could be used to produce multi-component powders for any suitable additive manufacturing method.

The system (201) of FIG. 7 includes a plurality of powder supplies (220-1, 220-2, to 220-n) and a corresponding plurality of powder reservoirs (221-1, 221-2, to 221-n), powder feedstocks (222-1, 222-2, to 222-n), platforms (223-1, 223-2, to 223-n), and adjustment devices (224-1, 224-2, to 224-n), as described above relative to FIGS. 6a-6c. Likewise, build space (210) includes a build reservoir (251), a build platform (253), and an adjustable device (254) coupled to the build platform (253), as described above relative to FIGS. 6a-6c.

A powder spreader 260 may be operable to move between (to and from) a first position (202a) and a second position (202b), the first position being upstream of the first powder supply (220-1), and the second position (202b) being downstream of either the last powder supply (220-n) or the build space (210). As powder spreader (260) moves from the first position (202a) towards the second position (202b), it will gather the appropriate volume of first feedstock (222-1) from the first powder supply (220-1), the appropriate volume of second feedstock (220-2) from the second powder supply (222-2), and so forth, thereby producing a gathered volume (228). The volumes and compositions of the first through final feedstocks (220-1 to 220-n) can be tailored and controlled for each rolling cycle to facilitate production of tailored 3-D multi-component alloy products, or portions thereof.

For instance, the first powder supply (220-1) may include a first metal powder (e.g., a one-metal powder) as its feedstock (222-1), and the second powder supply (220-2) may include a second metal powder (e.g., a multi-metal powder) as its feedstock (222-2). As powder spreader (260) moves from upstream of the first powder supply (220-1), along distribution surface (240), to downstream of the second powder supply (220-2), the powder spreader (260) may gather the first and second volumes of metal powders (222-1, 222-2), thereby producing a tailored powder blend (228) downstream of the second powder supply (220-2). As powder spreader (260) moves towards build reservoir (251), the first and second powders may mix (e.g., by tumbling, by applying vibration to upper surface (240), e.g., via optional vibratory apparatus 275), or by other mixing/stirring apparatus). Subsequent powder feedstocks (222-3 (not shown) to 222-n) may be utilized or avoided (e.g., by closing the top of the powder supply(ies)) as powder spreader (260) moves towards the second position (202b). Ultimately, a final powder feedstock (222=222_{1+2+ . . . N}) may be provided for additive manufacturing, such as for use in powder bed build space (210). A laser (188) may then be used, as described above relative to FIG. 6b, to produce a portion of the final tailored 3-D multi-component alloy part (250).

The flexibility of the system (201) facilitates the in-situ production of any of the products illustrated in FIGS. 1, 2a-2d, and 3a-3f, among others. Any suitable powders having any suitable composition, and any suitable particle size distributions may be used as the feedstocks (222-1 to 222-n) of the system (201). For instance, to produce a homogenous 3-D multi-component alloy product, such as that illustrated in FIG. 1, generally the same volumes and compositions for each rolling cycle may be utilized. To produced multi-region products, such as those illustrated in FIGS. 3a-3f, the powder spreader (260) may gather different volume(s) of feedstocks from the same or different powder supplies, as appropriate. As one example, to produce the layered product of FIG. 3a, a first rolling cycle may gather a first volume of feedstock (222-1) from the first powder supply (220-1), and a second volume of feedstock (222-2) from the second powder supply (220-2). For a subsequent cycle, and to produce a second, different layer, the height of the first powder supply (220-1) may be adjusted (via its platform) to provide a different volume of the first feedstock (222-1) (the height of the second powder supply (220-2) may remain the same or may also change). In turn, a different powder blend will be produced due to the different volume of the first feedstock utilized in the subsequent cycle, thereby producing a different layer of material.

As an alternative, the system (201) may be controlled such that powder spreader (260) only gathers materials from the appropriate powder supplies (220-2 to 220-n) to produce the desired material layers. For instance, the powder spreader (260) may be controlled to avoid the appropriate powder supplies (e.g., moving non-linearly to avoid). As another example, the powder supplies (220-1 to 220-n) may include selectively operable lids or closures, such that the system (201) can remove any appropriate powder supplies (220-1 to 220-n) from communicating with the powder spreader (260) for any appropriate cycle by selectively closing such lids or closures.

The powder spreader (260) may be controlled via a suitable control system to move from the first position (202a) to the second position (202b), or any positions therebetween. For instance, after a cycle, the powder spreader (260) may return to a position downstream of the first powder supply (220-1), and upstream of the second powder supply (220-2) to facilitate gathering of the appropriate volume of the second feedstock (222-2), avoiding the first feedstock (222-1) altogether. Further, the powder spreader (260) may be moved in a linear or non-linear fashion, as appropriate to gather the appropriate amounts of the feedstocks (222-1 to 222-n) for the additive manufacturing operation. Also, multiple rollers can be used to move and/or blend the feedstocks (222-1 to 222-n). Finally, while more than two powder supplies (222-1 to 222-n) are illustrated in FIG. 7, a system having only two powder supplies (222-1 to 222-2) may be useful as well.

The additive manufacturing apparatus and systems described in FIGS. 6a-6c and 7 may be used to make any suitable 3-D multi-component alloy product. In one embodiment, the same general powder is used throughout the additive manufacturing process to produce a multi-component alloy product. For instance, and referring now to FIG. 1, the final tailored multi-component alloy product (100) may comprise a single region/matrix produced by using generally the same metal powder during the additive manufacturing process. In one embodiment, the metal powder consists of one-metal particles. In one embodiment, the metal powder consists of a mixture of one-metal particles and multiple-metal particles. In one embodiment, the metal powder consists of one-metal particles and M-NM particles. In one embodiment, the metal powder consists of one-metal particles, multiple-metal particles and M-NM particles. In one embodiment, the metal powder consists of multiple-metal particles. In one embodiment, the metal powder consists of multiple-metal particles and M-NM particles. In one embodiment, the metal powder consists of M-NM particles. In any of these embodiments, non-metal particles may be optionally used in the metal powder. In any of these embodiments, multiple different types of the one-metal particles, the multiple-metal particles, the M-NM particles, and/or the non-metal particles may be used to produce the metal powder. For instance, a metal powder consisting of one-metal particles may include multiple different types of one-metal particles. As another example, a metal powder consisting of multiple-metal particles may include multiple different types of multiple-metal particles. As another example, a metal powder consisting of one-metal and multiple metal particles may include multiple different types of one-metal and/or multiple metal particles. Similar principles apply to M-NM and non-metal particles.

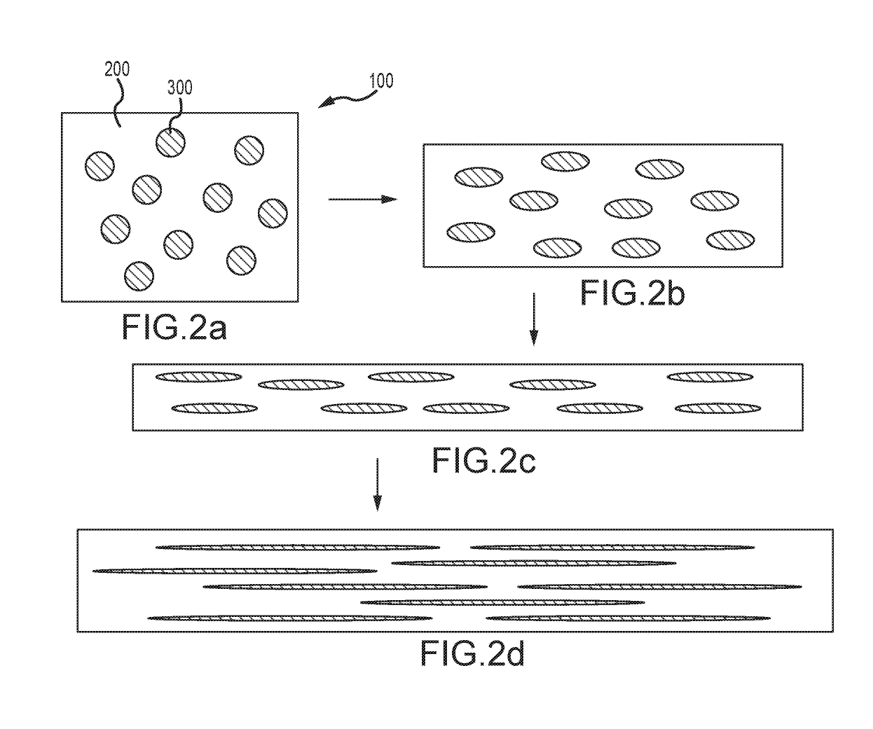

As one specific example, and with reference now to FIGS. 2a-2d, the single metal powder may include a blend of (1) at least one of (a) M-NM particles and (b) non-metal particles (e.g., BN particles) and (2) at least one of (a) one-metal particles or (b) multiple-metal particles. The single powder blend may be used to produce a multi-component alloy body having a large volume of a first region (200) and smaller volume of a second region (300). For instance, the first region (200) may comprise a multi-component alloy alloy region (e.g., due to the one-metal particles and/or multiple metal particles), and the second region (300) may comprise a M-NM region (e.g., due to the M-NM particles and/or the non-metal particles). After or during production, an additively manufactured product comprising the first region (200) and the second region (300) may be deformed (e.g., by one or more of rolling, extruding, forging, stretching, compressing), as illustrated in FIGS. 2b-2d. The final deformed product may realize, for instance, higher strength due to the interface between the first region (200) and the M-NM second region (300), which may restrict planar slip.

The final tailored multi-component alloy product may alternatively comprise at least two separately produced distinct regions. In one embodiment, different metal powder bed types may be used to produce a multi-component alloy product. For instance, a first metal powder bed may comprise a first metal powder and a second metal powder bed may comprise a second metal powder, different than the first metal powder. The first metal powder bed may be used to produce a first layer or portion of a multi-component alloy product, and the second metal powder bed may be used to produce a second layer or portion of the multi-component alloy product. For instance, and with reference now to FIGS. 3a-3f, a first region (400) and a second region (500), may be present. To produce the first region (400), a first portion (e.g., a layer) of a metal powder bed may comprise a first metal powder. To produce the second region (500), a second portion (e.g., a layer) of metal powder may comprise a second metal powder, different than the first layer (compositionally and/or physically different). Third distinct regions, fourth distinct regions, and so on can be produced using additional metal powders and layers. Thus, the overall composition and/or physical properties of the metal powder during the additive manufacturing process may be pre-selected, resulting in tailored multi-component alloy products having tailored compositions and/or microstructures.

In one aspect, the first metal powder consists of one-metal particles. The first metal powder may be used in a first metal powder bed layer to produce a first region (400) of a tailored multi-component alloy body. Subsequently, a second metal powder may be used as a second metal powder bed layer to produce a second region (500) of a tailored multi-component alloy body (e.g., as per FIG. 6c or FIG. 7), or may be blended with the first metal powder prior to being provided to the build reservoir (e.g., as per FIG. 7). In one embodiment, the second metal powder consists of another type of one-metal particles. In another embodiment, the second metal powder consists of one-metal particles and multiple-metal particles. In yet another embodiment, the second metal powder consists of one-metal particles and M-NM particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of multiple-metal particles. The first metal powder may be used in a first metal powder bed layer to produce a first region (400) of a tailored multi-component alloy body. Subsequently, a second metal powder may be used as a second metal powder bed layer to produce a second region (500) of a tailored multi-component alloy body (e.g., as per FIG. 6c or FIG. 7), or may be blended with the first metal powder prior to being provided to the build reservoir (e.g., as per FIG. 7). In one embodiment, the second metal powder consists of another type of multiple-metal particles. In another embodiment, the second metal powder consists of one-metal particles. In yet another embodiment, the second metal powder consists of a mixture of one-metal particles and multiple-metal particles. In another embodiment, the second metal powder consists of a mixture of one-metal particles and M-NM particles. In yet another embodiment, the second metal powder consists of one-metal particles, multiple-metal particles and M-NM particles. In another embodiment, the second metal powder consists of a mixture of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of M-NM particles. The first metal powder may be used in a first metal powder bed layer to produce a first region (400) of a tailored multi-component alloy body. Subsequently, a second metal powder may be used as a second metal powder bed layer to produce a second region (500) of a tailored multi-component alloy body (e.g., as per FIG. 6c or FIG. 7), or may be blended with the first metal powder prior to being provided to the build reservoir (e.g., as per FIG. 7). In one embodiment, the second metal powder consists of another type of M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of one-metal particles, multiple-metal particles and M-NM particles. In another embodiment, the second metal powder consists of multiple-metal particles. In another embodiment, the second metal powder consists of multiple-metal particles and M-NM particles. In any of these embodiments, non-metal particles may be optionally used in the second metal powder to produce the second region.

In another aspect, the first metal powder consists of a mixture of one-metal particles and multiple-metal particles. The first metal powder may be used in a first metal powder bed layer to produce a first region (400) of a tailored multi-component alloy body. Subsequently, a second metal powder may be used as a second metal powder bed layer to produce a second region (500) of a tailored multi-component alloy body (e.g., as per FIG. 6c or FIG. 7), or may be blended with the first metal powder prior to being provided to the build reservoir (e.g., as per FIG. 7). In one embodiment, the second metal powder consists of another mixture of one-metal particles and multiple metal particles. In another embodiment, the second metal powder consists of one-metal particles. In yet another embodiment, the second metal powder consists of one-metal particles and M-NM particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of a mixture of one-metal particles and M-NM particles. The first metal powder may be used in a first metal powder bed layer to produce a first region (400) of a tailored multi-component alloy body. Subsequently, a second metal powder may be used as a second metal powder bed layer to produce a second region (500) of a tailored multi-component alloy body (e.g., as per FIG. 6c or FIG. 7), or may be blended with the first metal powder prior to being provided to the build reservoir (e.g., as per FIG. 7). In one embodiment, the second metal powder consists of another mixture of one-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles, multiple-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of a mixture of one-metal particles, multiple-metal particles and M-NM particles. The first metal powder may be used in a first metal powder bed layer to produce a first region (400) of a tailored multi-component alloy body. Subsequently, a second metal powder may be used as a second metal powder bed layer to produce a second region (500) of a tailored multi-component alloy body (e.g., as per FIG. 6c or FIG. 7), or may be blended with the first metal powder prior to being provided to the build reservoir (e.g., as per FIG. 7). In one embodiment, the second metal powder consists of another mixture of one-metal particles, multiple-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of multiple-metal particles. In another embodiment, the second metal powder consists of multiple-metal particles and M-NM particles. In yet another embodiment, the second metal powder consists of M-NM particles. In any of these embodiments, non-metal particles may be optionally used in the second metal powder to produce the second region.

In another aspect, the first metal powder consists of a mixture of multiple-metal particles and M-NM particles. The first metal powder may be used in a first metal powder bed layer to produce a first region (400) of a tailored multi-component alloy body. Subsequently, a second metal powder may be used as a second metal powder bed layer to produce a second region (500) of a tailored multi-component alloy body (e.g., as per FIG. 6c or FIG. 7), or may be blended with the first metal powder prior to being provided to the build reservoir (e.g., as per FIG. 7). In one embodiment, the second metal powder consists of another mixture of multiple-metal particles and M-NM particles. In another embodiment, the second metal powder consists of one-metal particles. In yet another embodiment, the second metal powder consists of one-metal particles and multiple-metal particles. In another embodiment, the second metal powder consists of one-metal particles and M-NM particles. In yet another embodiment, the second metal powder consists of multiple-metal particles. In another embodiment, the second metal powder consists of one-metal particles, multiple-metal particles and M-NM particles. In yet another embodiment, the second metal powder consists of M-NM particles. In any of these embodiments, non-metal particles may be optionally used in the second metal powder to produce the second region.

Thus, the systems and apparatus of FIGS. 6a-6c and 7 may be useful in producing a variety of additively manufactured 3-D multi-component alloy products, where at least four different elements making up the metal matrix of a product, and where the multi-component product comprises 5-35 at. % of the at least four elements.

The powders used to in the additive manufacturing processes described herein may be produced by atomizing a material (e.g., an ingot) of the appropriate material into powders of the appropriate dimensions relative to the additive manufacturing process to be used.

After or during production, an additively manufactured product may be deformed (e.g., by one or more of rolling, extruding, forging, stretching, compressing). The final deformed product may realize, for instance, improved properties due to the tailored regions of the multi-component alloy product.

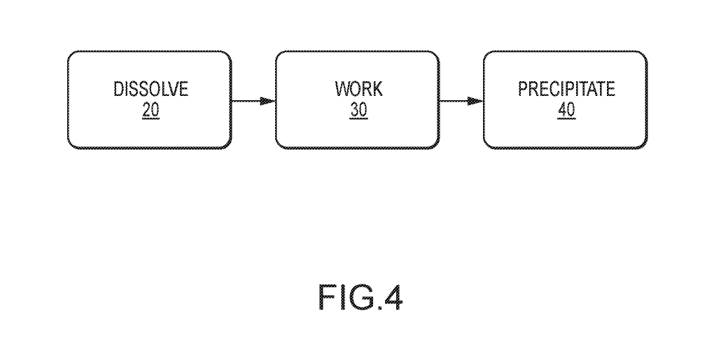

Referring now to FIG. 4, the additively manufactured product may be subject to any appropriate dissolving (20), working (30) and/or precipitation hardening steps (40). If employed, the dissolving (20) and/or the working (30) steps may be conducted on an intermediate form of the additively manufactured body and/or may be conducted on a final form of the additively manufactured body. If employed, the precipitation hardening step (40) is generally conducted relative to the final form of the additively manufactured body.

With continued reference to FIG. 4, the method may include one or more dissolving steps (20), where an intermediate product form and/or the final product form are heated above a solvus temperature of the product but below the solidus temperature of the material, thereby dissolving at least some of the undissolved particles. The dissolving step (20) may include soaking the material for a time sufficient to dissolve the applicable particles. In one embodiment, a dissolving step (20) may be considered a homogenization step. After the soak, the material may be cooled to ambient temperature for subsequent working. Alternatively, after the soak, the material may be immediately hot worked via the working step (30).

The working step (30) generally involves hot working and/or cold working an intermediate product form. The hot working and/or cold working may include rolling, extrusion or forging of the material, for instance. The working (30) may occur before and/or after any dissolving step (20). For instance, after the conclusion of a dissolving step (20), the material may be allowed to cool to ambient temperature, and then reheated to an appropriate temperature for hot working. Alternatively, the material may be cold worked at around ambient temperatures. In some embodiments, the material may be hot worked, cooled to ambient, and then cold worked. In yet other embodiments, the hot working may commence after a soak of a dissolving step (20) so that reheating of the product is not required for hot working.

The working step (30) may result in precipitation of second phase particles. In this regard, any number of post-working dissolving steps (20) can be utilized, as appropriate, to dissolve at least some of the undissolved second phase particles that may have formed due to the working step (30).

After any appropriate dissolving (20) and working (30) steps, the final product form may be precipitation hardened (40). The precipitation hardening (40) may include heating the final product form above a solvus temperature for a time sufficient to dissolve at least some particles precipitated due to the working, and then rapidly cooling the final product form. The precipitation hardening (40) may further include subjecting the product to a target temperature for a time sufficient to form precipitates (e.g., strengthening precipitates), and then cooling the product to ambient temperature, thereby realizing a final aged product having desired precipitates therein. As may be appreciated, at least some working (30) of the product may be completed after a precipitating (40) step. In one embodiment, a final aged product contains ≧0.5 vol. % of the desired precipitates (e.g., strengthening precipitates) and ≦0.5 vol. % of coarse second phase particles.

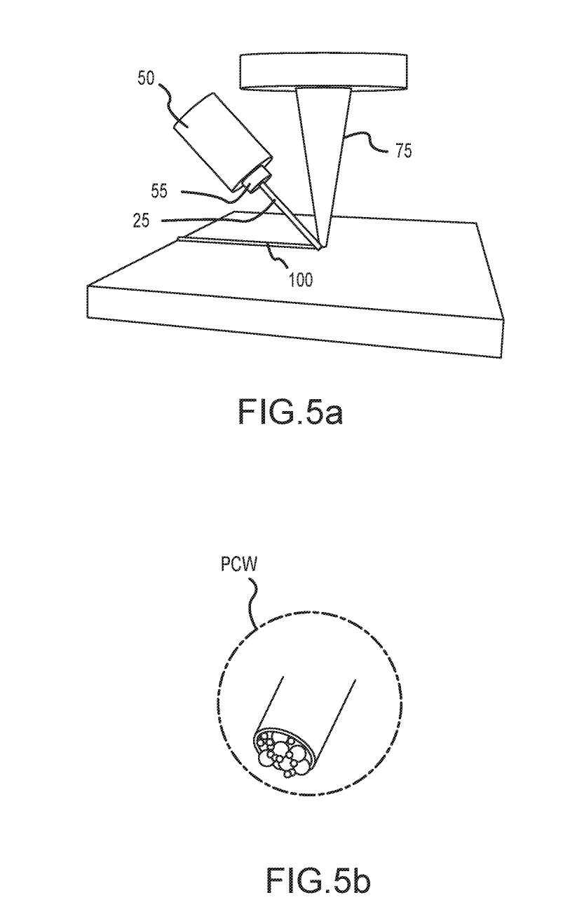

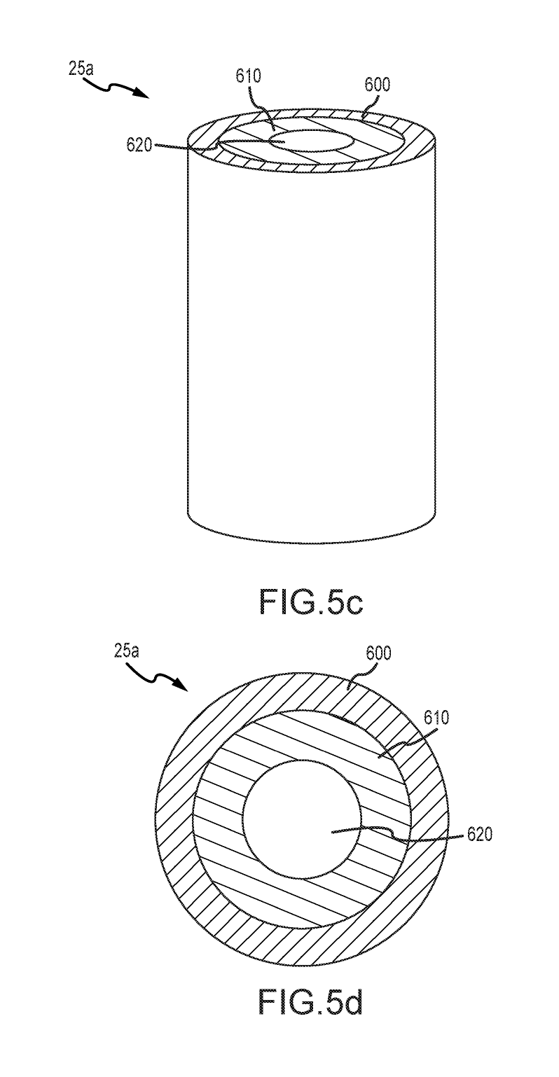

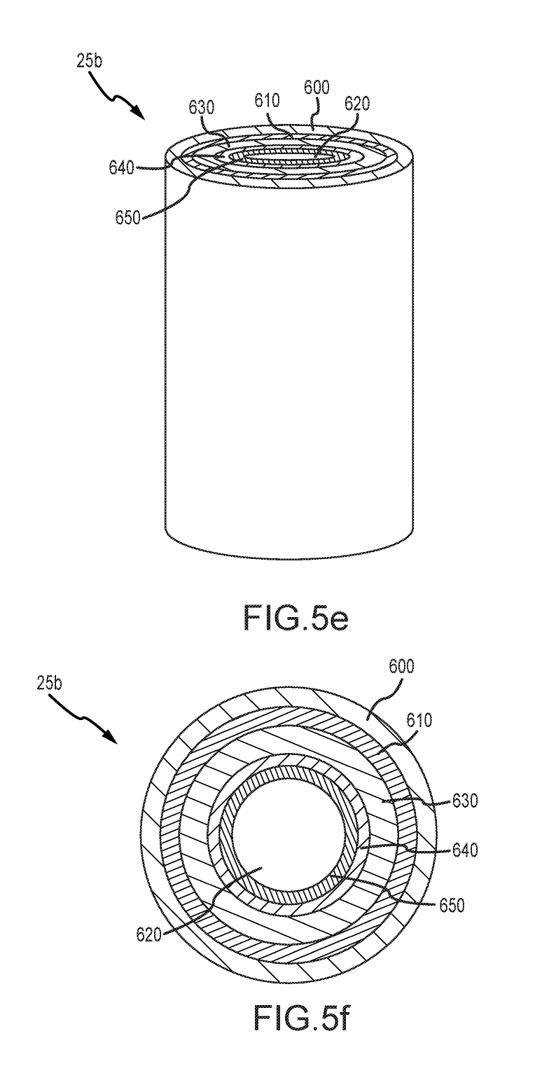

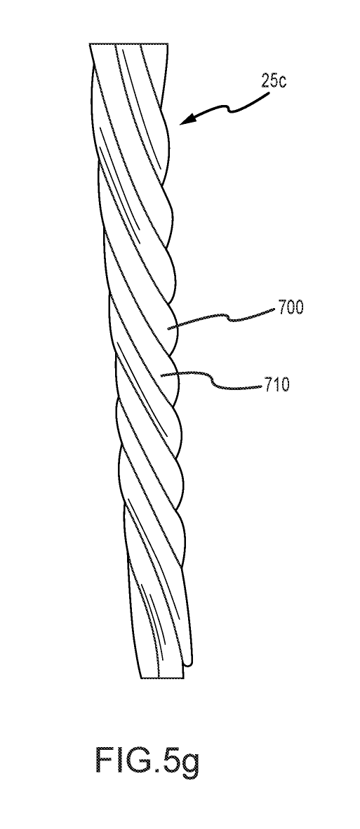

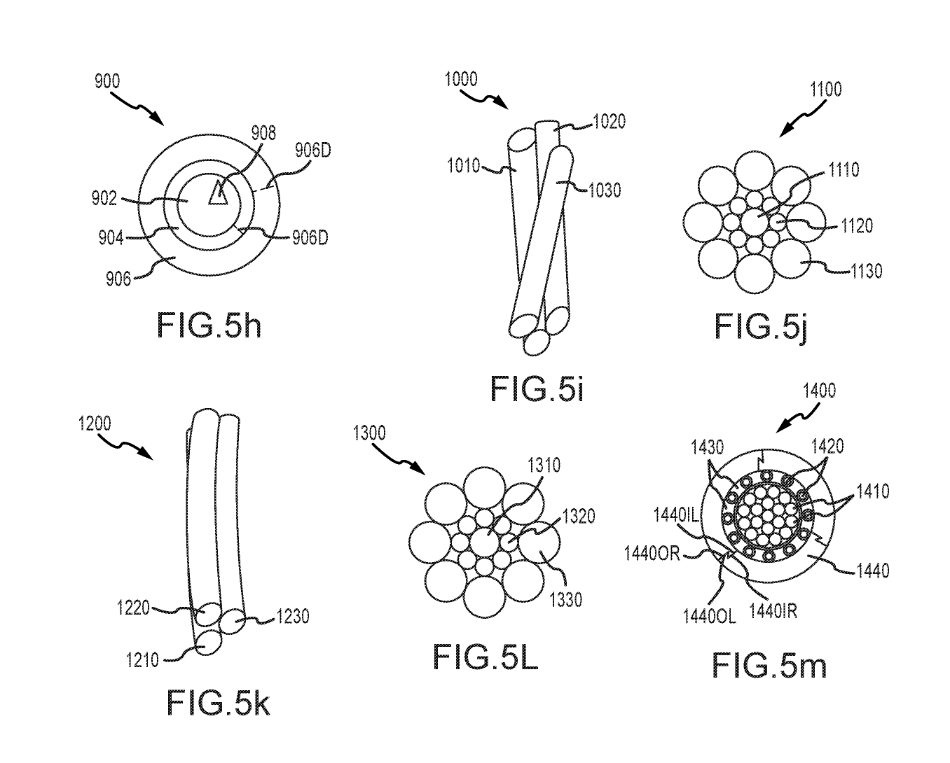

In one approach, electron beam (EB) or plasma arc techniques are utilized to produce at least a portion of the additively manufactured multi-component alloy body. Electron beam techniques may facilitate production of larger parts than readily produced via laser additive manufacturing techniques. For instance, and with reference now to FIG. 5a, in one embodiment, a method comprises feeding a small diameter wire (25) (e.g., ≦2.54 mm in diameter) to the wire feeder portion (55) of an electron beam gun (50). The wire (25) may be of the compositions, described above, provided it is a drawable composition (e.g., when produced per the process conditions of U.S. Pat. No. 5,286,577), or the wire is producible via powder conform extrusion, for instance (e.g., as per U.S. Pat. No. 5,284,428). The electron beam (75) heats the wire or tube, as the case may be, above the liquidus point of the body to be formed, followed by rapid solidification (e.g., ≧100° C. per second) of the molten pool to form the deposited material (100). These steps may be repeated as necessary until the final multi-component alloy body is produced.

In one embodiment, and referring now to FIG. 5b, the wire (25) is a powder cored wire (PCW), where a tube portion of the wire contains a volume of the particles therein, such as any of the particles described above (one-metal particles, multiple metal particles, metal-nonmetal particles, non-metal particles, and combinations thereof), while the tube itself may comprise any composition suitable to produce the appropriate end composition of a multi-component alloy product. In one embodiment, the tube is an alloy and the particles held within the tube, as shown in FIG. 5b, are selected from the group consisting of one-metal particles, multiple metal particles, metal-nonmetal particles, non-metal particles, and combinations thereof.

In another embodiment, and referring now to FIGS. 5c-5d, the wire (25a) is a multiple-tube wire having first elongate outer tube portion (600) and at least a second elongate inner tube portion (610). The first portion (600) comprises a first material, and the second portion (610) comprises a second material, generally different than the first material. The wire (25a) may include a hollow core (620), as shown, or may include a solid core or may include a volume of particles within the core, as described above relative to FIGS. 5a-5b. In any event, the collective compositions of the first material, the second material and any materials of the core are such that, after deposition, the multi-component alloy product comprises a metal matrix, and the metal matrix is a result of the collective compositions of the first material, the second material and any materials of the core. Thus, the resultant multi-component alloy product includes a metal matrix having at least four different elements making-up the matrix, and where the multi-component product comprises 5-35 at. % of the at least four elements. As described above, the collective composition of the first material, the second material and any materials of the core may be tailored to achieve a metal matrix composed of at least five, or at least six, or at least seven, or at least eight different elements, or more, where the multi-component product comprises 5-35 at. % of the at least five, or at least six, or at least seven, or at least eight, or more, different elements. The thickness of the first elongate outer tube portion (600) and the at least second elongate inner tube portion (610) may be tailored to provide the appropriate end composition for the metal matrix. Further, as shown in FIGS. 5e-5f, a wire (25b) may include any number of multiple elongate tubes (e.g., tubes 600-610 and 630-650) each of the appropriate composition and thickness to provide the appropriate end composition for the metal matrix. As described above relative to FIG. 5c-5d, the core (620) may be a hollow core (620), as shown, or may include a solid core or may include a volume of particles within the core, as described above relative to FIGS. 5a-5b.

In another embodiment, and referring now to FIG. 5g, the wire (25c) is a multiple-fiber wire having a first fiber (700) and at least a second fiber (710) intertwined with the first wire (700). The first fiber (700) comprises a first material, and the second portion (710) comprises a second material, generally different than the first material. The collective compositions of the first material and the second material are such that, after deposition, the multi-component alloy product comprises a metal matrix, and the metal matrix is a result of the collective compositions of the first material and the second material. Thus, the resultant multi-component alloy product includes a metal matrix having at least four different elements making-up the matrix, and where the multi-component product comprises 5-35 at. % of the at least four elements. As described above, the collective composition of the first material and the second material may be tailored to achieve a metal matrix composed of at least five, or at least six, or at least seven, or at least eight different elements, or more, where the multi-component product comprises 5-35 at. % of the at least five, or at least six, or at least seven, or at least eight, or more, different elements.

Another example of a wire useful in producing multi-component alloy products is shown in FIG. 5h. In the illustrated embodiment, a wire 900 comprises a compound structure, with a first portion (core) 902 made of a first material and second and third portions 904, 906 made from second and third materials, respectively. As noted above, the wire 900 may be utilized for welding, cladding or additive manufacture. An insert (fourth portion) 908 of a fourth material is optionally positioned within the core 902. This composition of the wire 900 is only an example and more or less portions may be utilized. In other embodiments, tubes and other portions having a variety of shapes that can be cast, drawn, extruded or otherwise formed are incorporated into the wire. In the instance of a wire made from a plurality of bodies, the plurality of portions are held together to form an identifiable unitized structure, e.g., wire 900. In FIG. 5h, the core 902 has a generally cylindrical configuration and is enrobed by second and third portions 904, 906 in coaxial relationship. This is not required, as shown by fourth portion 908, which has a triangular cross-section displaced from the axis of the wire 900. The geometry, e.g., cross-sectional area, of the first, second, third and fourth portions 902, 904, 906, 908 determine the percent composition, by weight, of each of the materials from which they are made for any given length of the wire 900 (not shown—but extending perpendicular to the cross-section). In another embodiment, a given portion, e.g., 908 of the wire 900, may be replicated a desired plurality of times. For example, if twice as much weight percent of the fourth material is desired for the resultant multi-component material that is formed from the wire, a second insert like fourth portion 908 can be included in the wire 900. Any number of portions 902, 904, 906, 908 of the wire 900 may be used having any given dimensions and count, such that the percent composition of the resultant multi-component alloy product may be selectively determined.

In the instance of a monolithic wire, the monolith may have an origin in a plurality of different materials of different composition. In a first approach, an alloy formed with the desired weight composition of each element is cast and formed into a wire, like wire 900. In another embodiment, wire 900 may be composed of a solid core of a first material, upon which is deposited one or more outer layers, such as second and third portions 904, 906. The outer portions 904, 906 may be coated on the core, e.g., by dipping the core 902 in a melt of the second material and allowing the second material to solidify around the core 902 forming the second portion 904, followed by a similar process for enrobing the second portion 904 with a third portion 906 by dipping in a melt of the third material. Alternatively, the second and third portions can be joined to the core by chemical or physical processes, such as electroplating or spray deposition. In one embodiment, the second and/or third portions 904, 906 may be separately formed of a malleable sheet or strip that is then bent around the core 902 as indicated by the dotted lines 904D and 906D indicating conjoined ends, representing a mechanical approach for forming the wire 900. The materials of the portions 902, 904, 906, 908 can be in various physical forms. In one example, the core 902 may be formed of powdered metal or metal particles, such as shavings that are closely compressed by the second and third portions 904, 906. In another example, the core may be a solidified mass of metal particles and a flux compound. In another example, the core may be a solid metal filament or extrusion. While four portions 902, 904, 906, 908 are shown in FIG. 5h, any number of portions may be used, ranging from one to a large multitude.

The material compositions for the wire(s) may be selected for utility in welding, cladding and/or additive manufacture. With respect to welding and cladding, the composition may be selected to join dissimilar materials by providing a multi-component alloy that is compatible with both. The wire 900 may be formed from a plurality of portions, e.g., 902, 904 of materials with different compositions. These portions, e.g., 902, 904 could be denominated “pre-alloys” that when combined under processing parameters achievable with the desired welding equipment will form, in situ, the desired multi-component alloy for use in welding, cladding or additive manufacturing. For example, a first pre-alloy material may be the core portion 902 of the wire 900 and the second pre-alloy material may be the outer portion 904. The number of portions 902, 904, 906, 908 can be varied to achieve a given percent composition for the multi-component alloy. In one embodiment, different physical portions, e.g., 902 and 906 may be of the same material composition and different from the material composition of another portion, e.g., 906, 908 in order to achieve the target percent composition of the multi-composition alloy within geometric constraints imposed by wire 900 dimensions.

FIG. 5i shows another embodiment of the present disclosure, where a wire 1000 has multiple strands or portions 1010, 1020, 1030, which may be formed from materials having the same or different compositions. FIG. 5i also shows one method by which the strands or portions 1010, 1020, 1030 may be mechanically intertwined to form a unitized structure, i.e., wire 1000. More particularly, the strand 1030 is spiraled around strands 1010, 1020 with strand 1030 crossing strand 1020 at an angle. This results in point contact between strand 1030 and strand 1020 and can also be seen in FIG. 5j, where strands 1110, 1120 and 1130 are analogous to strands 1010, 1020, 1030 of FIG. 10, though more numerous and of varying cross-section, so as to facilitate a more dense wire/more efficient use of surface area. In FIG. 5j, strands 1130 make point contact with strands 1120. Strands 1120 are generally parallel to center strand 1110. This particular type of winding arrangement (cross-lay) may be utilized when a central strand like 1110 or intermediate strands 1120 are resistant to bending due to composition and an outer strand or strands 1130 are more ductile, such that they can be bent into a spiral configuration winding about and embracing the other strands 1110, 1120 to hold them into a unitized wire structure 1100. The number of windings per unit length can be utilized to determine the percent composition that the spirally wound material (portion) 1030 contributes to the multi-component alloy. The unitized wire 1100 may then be conveniently handled, e.g., as a welding rod or electrode. Cross lay arrangements are better able to tolerate casual handling (multiple bends). As described above, the relative percent composition of the wires 1000 and 1100 is determined by the number of strands/portions, e.g., 1110, 1120, 1130 of each composition and their dimensions. The percent composition of the resultant multi-composition alloy that is produced when the wire 1000, 1100 is melted can therefore be controlled by selecting these parameters. The percent composition and distribution of composition across the cross-section of the wire 1100 may be controlled by varying the composition of the portions 1110, 1120, 1130. For example, the strands making up portion 1130, which are eight in number in FIG. 5j, may all be made of one type of material or may have a selective number of strands of different types of materials. Similarly, the strands of portion 1120 may be of varying composition. The present disclosure allows for any given number of portions and any dimensions for the portions, e.g., 1110, 1120, 1130. In one example, a wire having thirty five strands may have strands with fourteen different compositions, none, some or all strands having the same or different cross-sectional areas.

FIGS. 5k and 5l show another approach with wire 1200 having strands/portions 1210, 1220, 1230 that are generally parallel and nest more closely, creating a more compact wire 1200. The same principles can be seen in FIG. 5l where the wire 1300 has a compact configuration due to the close nesting of parallel strands/portions 1310, 1320, 1330. This type of configuration (parallel lay) lends itself to a twisted structure wherein at least some of the strands 1310, 1320, 1330 have a ductility that permits them to retain a set deformation without unwinding. Parallel lay arrangements may have high breaking strength and favorable fatigue bending characteristics, but can be susceptible to untwisting.

FIG. 5m shows another embodiment of the present disclosure, where a wire 1400 has a plurality of inner strands/portions 1410 having a generally circular cross-sectional shape surrounded by a second plurality of strands/portions 1420 having a generally circular cross-sectional shape, but larger in diameter than the inner portions 1410. A third plurality of intermediate members/portions 1430 space the second plurality of portions 1420 around the periphery of the bundle of inner portions 1410 and have a compound shape that may be formed, e.g., by extrusion. A fourth plurality of interlocking members/portions 1440 surround the strands 1420 and members 1430. The portions 1440 have inner and outer recesses 144018, 14400R and mating inner and outer lips 14401L, 14400L that interlock and restrain the portions 1440 from unwinding relative to one another. The strands/portions 1410, 1420, and members/portions 1430, 1440 may be made by conventional processes, such as extrusion, drawing, rolling or casting. As in prior examples, the dimensions of the portions 1410, 1420, 1430, 1440 and their respective number (count) determine the compositional percent that they contribute to the resultant multi-compositional alloy when they are melted together during the course of cladding, welding or additive manufacture. In one embodiment, the number of windings per unit length determines the percent composition of the material in the final multi-component alloy. The materials of composition for the portions, e.g., 1410, 1420, 1430 may be selected and placed in a given arrangement to be compatible with operating parameters, such as duty cycle, energy level, shield gas, etc. to form, in situ, the desired multi-component alloy for welding, cladding or additive manufacturing. In applications where there is a concern for unwanted interaction occurring between the strands of the feedstock arrangements, otherwise interacting strands/portions may be separated from one another, e.g., by an intervening strand/portion or other separator.

In another embodiment, not illustrated, an electron beam (EB) or plasma arc additive manufacturing apparatus may employ multiple different wires with corresponding multiple different radiation sources, each of the wires and sources being fed and activated, as appropriate to provide the appropriate multi-component alloy product having a metal matrix, the metal matrix having at least four different elements making-up the matrix, and where the multi-component product comprises 5-35 at. % of the at least four elements.

In another approach, a method may comprise (a) selectively spraying one or more metal powders (as defined above) towards a building substrate, (b) heating, via a radiation source, the metal powders, and optionally the building substrate, above the liquidus temperature of the particular multi-component alloy product to be formed, thereby forming a molten pool, (c) cooling the molten pool, thereby forming a solid portion of the multi-component alloy product, wherein the cooling comprises cooling at a cooling rate of at least 100° C. per second. In one embodiment, the cooling rate is at least 1000° C. per second. In another embodiment, the cooling rate is at least 10,000° C. per second. The cooling step (c) may be accomplished by moving the radiation source away from the molten pool and/or by moving the building substrate having the molten pool away from the radiation source. Steps (a)-(c) may be repeated as necessary until the multi-component alloy product is completed. The spraying step (a) may be accomplished via one or more nozzles, and the composition of the metal powders can be varied, as appropriate, to provide tailored final multi-component alloy products having a metal matrix, the metal matrix having at least four different elements making-up the matrix, and where the multi-component product comprises 5-35 at. % of the at least four elements. The composition of the metal powder being heated at any one time can be varied in real-time by using different powders in different nozzles and/or by varying the powder composition(s) provided to any one nozzle in real-time. The work piece can be any suitable substrate. In one embodiment, the building substrate is, itself, a multi-component alloy product.

As noted above, welding may be used to produce multi-component alloy products. In one embodiment, the multi-component alloy product is produced by a melting operation applied to pre-cursor materials in the form of a plurality of metal components of different composition. The pre-cursor materials may be presented in juxtaposition relative to one another to allow simultaneous melting and mixing. In one example, the melting occurs in the course of electric arc welding, In another example, the melting may be conducted by a laser or an electron beam during additive manufacturing. The melting operation results in the plurality of metal components mixing in a molten state and forming a new alloy that is the multi-element product. The pre-cursor materials may be provided in the form of a plurality of physically separate forms, such as a plurality of elongated strands or fibers of metals or metal alloys of different composition or an elongated strand or a tube of a first composition and an adjacent powder of a second composition, e.g., contained within the tube or a strand having one or more clad layers. The pre-cursor materials may be formed into a structure, e.g., a twisted or braided cable or wire having multiple strands or fibers or a tube with an outer shell and a powder contained in the lumen thereof. The structure may then be handled to subject a portion thereof, e.g., a tip, to the melting operation, e.g., by using it as a welding electrode or as a feed stock for additive manufacturing. When so used, the structure and its component pre-cursor materials may be melted, e.g., in a continuous or discrete process to form a weld bead or a line or dots of material deposited for additive manufacture.

In one embodiment, the multi-component product is a weld body or filler interposed between and joined to a material or material to the welded, e.g., two bodies of the same or different material or a body of a single material with an aperture that the filler at least partially fills. In another embodiment, the filler exhibits a transition zone of changing composition relative to the material to which it is welded, such that the resultant combination could be considered the multi-component product.

While various embodiments of the new technology described herein have been described in detail, it is apparent that modifications and adaptations of those embodiments will occur to those skilled in the art. However, it is to be expressly understood that such modifications and adaptations are within the spirit and scope of the presently disclosed technology.

What is claimed is:

1. A method for producing a multi-component alloy product, the method comprising:
(a) dispersing a metal powder in a bed and/or spraying a metal powder towards or on a substrate, wherein the metal powder comprises at least four different elements of the periodic table;
(b) selectively heating a portion of the metal powder to a temperature above the liquidus temperature of the multi-component alloy product;
(c) forming a molten pool;
(d) cooling the molten pool at a cooling rate of at least 1000° C. per second; and
(e) repeating steps (a)-(d) until the multi-component alloy product is completed, wherein the multi-component alloy product comprises a metal matrix, wherein the at least four different elements make-up the matrix, and wherein the multi-component product comprises 5-35 at. % of the at least four elements.

2. The method for claim 1, wherein the at least four different elements are selected from the group consisting of Al, Si, Li, Be, Mg, Ca, Sr, Ti, V, Cr, Mn, Fe, Co, Ni, Cu, Zn, Zr, Nb, Mo, Ru, Rh, Pd, Ag, Hf, Ta, W, Re, Pt, Au, Ga, Ge, In, Sn, Pb, Bi, and the rare earth elements.

3. The method of claim 1, wherein the metal powder comprises at least some one-metal particles.

4. The method of claim 1, wherein the metal powder comprises at least some multiple-metal particles.

5. The method of claim 1, wherein the metal powder comprises at least some metal-nonmetal particles.

6. The method of claim 5, wherein the metal-nonmetal particles comprise at least one of oxygen, carbon, nitrogen and boron.

7. The method of claim 5, wherein the metal-nonmetal particles are selected from the group consisting of metal oxide particles, metal carbide particles, metal nitride particles, and combinations thereof.

8. The method of claim 5, wherein the metal-nonmetal particles are one of Al₂O₃, TiC, Si₃N₄ and TiB₂.

9. A wire for use in electron beam or plasma arc additive manufacturing, the wire comprising:
an outer tube portion comprising a first material; and
a volume of particles contained within the outer tube portion, the volume of particles being a second material;
wherein the composition of the wire, comprising the first material and the second material, is sufficient to produce a multi-component alloy product when the wire is used in additive manufacturing, wherein the multi-component alloy product comprises at least four elements, and wherein the multi-component alloy product comprises from 5-35 at. % each of the least four elements.

10. A method comprising:
first gathering a first feedstock from a first powder supply of an additive manufacturing system;
second gathering a second feedstock from a second powder supply of the additive manufacturing system;
combining the first and second feedstocks, thereby producing a metal powder blend, wherein the composition of the metal powder blend is sufficient to produce a multi-component alloy product, wherein the multi-component alloy product comprises at least four elements, and wherein the multi-component alloy product comprises from 5-35 at. % each of the least four elements.

11. The method of claim 10, wherein the first gathering comprises mechanically pushing the first feedstock via a roller, and wherein the second gathering comprises mechanically pushing the second feedstock via the roller.

12. The method of claim 11, comprising:
pushing the first feedstock towards the second feedstock via the roller.

13. The method of claim 12, wherein the providing step comprises:
pushing the blended feedstock from downstream of the second powder supply to the build space.

14. The method of claim 10, wherein the first gathering step comprises:
adjusting a height of a platform of the first powder supply, thereby providing a first volume of the first feedstock for the first gathering step.

15. The method of claim 14, comprising:
after the first gathering step, moving the height of the platform, thereby providing a third feedstock, wherein the third feedstock is a second volume of the first feedstock.

16. The method of claim 15, comprising:
third gathering the third feedstock from the first powder supply;
forth gathering a second feedstock from the second powder supply; and
combining the third feedstock and the second feedstock.

17. The method of claim 16, wherein the second gathering and the forth gathering steps gather an equivalent volume of the second feedstock.

18. The method of claim 10, comprising:
producing a tailored 3-D multi-component alloy product in the build space of the additive manufacturing system using the metal powder blend, wherein the wherein the multi-component alloy product comprises at least four elements, and wherein the multi-component alloy product comprises from 5-35 at. % each of the least four elements.

19. The method of claim 18, wherein the 3-D multi-component alloy product is an oxide dispersion strengthened 3-D multi-component alloy product having M-O particles therein, wherein M is a metal and O is oxygen.

20. The method of claim 19, wherein the M-O particles are selected from the group consisting of Y₂O₃, Al₂O₃, TiO₂, La₂O₃, and combinations thereof.
